(19) United States
(12) Patent Application Publication
(10) Pub. No.: US 2003/0010794 A1
(43) Pub. Date: Jan. 16, 2003

(54) Metering valve for a metered dose inhaler having improved flow

(75) Inventors: Thomas Herdtle, Inver Grove Heights, MN (US); Gustavo H. Castro, Cottage Grove, MN (US); Cathleen M. Arsenault, Hugo, MN (US)

Correspondence Address: Attention: Christopher D. Gram, Office of Intellectual Property Counsel, 3M Innovative Properties Company, P.O. Box 33427, St. Paul, MN, 55133-3427, US

(73) Assignee: 3M Innovative Properties Company

(21) Appl. No.: 10/146,216

(22) Filed: May 14, 2002

Related U.S. Application Data
(60) Provisional application No. 60/300,287, filed on Jun. 22, 2001.

(51) Int. Cl. B67D 5/64

(52) U.S. Cl. 222/162

(57) ABSTRACT

A novel metering valve having improved flow for delivery of an aerosol formulation is disclosed. Methods of improving the flow characteristics of a metering valve are also disclosed.

This application claims the benefit of U.S. provisional patent application Ser. No. 60/300, 287, filed Jun. 22, 2001.

### BACKGROUND

Metering valves are common means by which aerosols are dispensed from aerosol containers. Metering valves are particularly useful for administering medicinal formulations that include a liquefied gas propellant and are delivered to a patient in an aerosol.

When administering medicinal formulations, the proper, predetermined amount of the formulation in each successive dose must be dispensed to the patient. In this way, a dose of formulation sufficient to produce the desired physiological response is delivered to the patient. Any dispensing system must be able to dispense doses of the medicinal formulation accurately and reliably to help assure the safety and efficacy of the treatment.

Metering valves have been developed to provide control over the dispensing of medicinal aerosol formulations. A metering valve regulates the volume of a medicinal formulation passing from a container to a patient via a metering chamber. The metering chamber thus defines the maximum amount of the formulation that will be dispensed as the next dose. Reliable and controllable flow of the medicinal formulation into the metering chamber is therefore highly desirable.

In some metering valves, the metering chamber fills with the medicinal formulation prior to the patient actuating the valve stem and thereby releasing the dose. After dispensing one dose, the metering chamber is refilled with formulation so that it is ready to discharge the next dose. Consequently, the metering chamber is full of the formulation at all times except for the brief time during which the valve stem is depressed by the user to discharge a dose. Also, the passageways through which the bulk formulation must flow to reach the metering chamber are often narrow and tortuous. As a result, metering valves configured in this way have a number of disadvantages resulting in, for example, erratic dosing due to loss of prime.

In other metering valves, the metering chamber does not materialize unless and until the valve stem is actuated. Generally, such metering valves have a small annular gap between the external surface of the valve stem and the internal surface of a surrounding valve body, i.e., the tight region between the valve stem and the body wall in which the valve stem and the body wall are in close proximity. As the valve stem is actuated, formulation flows through an inlet and into the small annular gap and the nascent, transient metering chamber, the formation of which is described below.

Actuation of the valve stem in such a metering valve can be divided into a filling stage and a discharge stage. The filling stage begins as the valve stem is depressed during actuation. The action of depressing the valve stem causes the development of a transient metering chamber. As the valve stem is depressed, the transient metering chamber expands and formulation enters the metering chamber. As displacement of the valve stem continues, a stage is reached at which filling of the transient metering chamber stops. Eventually, displacement of the valve stem continues to the discharge stage, in which the metered formulation is discharged. In these valves, a single actuation thus causes rapid filling of the transient metering chamber followed by discharge of the formulation to the patient. Thus, the metered formulation does not reside for any appreciable amount of time in the metering chamber. Such metering valves may provide delivery of more consistent doses of formulation than may be provided by metering valves in which the metering chamber fills with formulation before the valve stem is actuated.

While a metering valve having a transient metering chamber provides advantages over other types of metering valves for the delivery of aerosol formulations, the flow of formulation from the container to the metering chamber still may be disrupted or impeded. When this happens, formulation may be delivered in inconsistent or inaccurate doses.

What is needed is a metering valve for a metered dose inhaler that improves flow of formulation into the metering chamber, thereby providing consistent, accurate, dosages of formulation.

### SUMMARY

It has been determined that one cause of disrupted or impeded flow of formulation may be due to the design of the metering valve. The length of the annular gap between the valve stem and the valve body may impact the flow of formulation into the nascent metering chamber. The length of the annular gap may be defined by the boundaries of a tight region between the valve stem and the body wall, i.e., a region in which the valve stem and the valve body are in relatively close proximity to each other. Generally, a metering valve including a relatively longer annular gap may provide an increased risk of turbulence, recirculation or an increased drop in pressure in the flow of formulation into the metering chamber, any or all of which may disrupt or impede the flow of formulation. Conversely, a metering valve including a relatively shorter annular gap may provide improved flow of formulation.

Accordingly, the present invention provides an aerosol metering valve including a body wall defining an internal chamber and comprising a metering gasket and a diaphragm, the diaphragm having walls defining an aperture; a valve stem comprising a body portion and a stem portion, the body portion comprising a bottom edge and being positioned in the internal chamber of the metering valve, the stem portion comprising a discharge outlet and passing through the aperture in slidable, sealing engagement with the diaphragm; an annular gap comprising an inlet and having a length of about 3.2 mm or less, defined by a distance from the bottom edge of the body portion of the valve stem to the inlet; and a flow path providing at least transient fluid communication between the internal chamber and the annular gap through the inlet.

In another aspect, the present invention provides an aerosol metering valve including a body wall defining an internal chamber and comprising a metering gasket and a diaphragm, the diaphragm having walls defining an aperture; a valve stem comprising a body portion and a stem portion, the body portion comprising a bottom edge and being positioned in the internal chamber of the metering valve, the stem portion comprising a discharge outlet and passing through the aperture in slidable, sealing engagement with the diaphragm; an annular gap comprising an inlet and having a width defined by a distance from the body wall to the valve stem, and also having a length defined by a distance from the inlet to the bottom edge of the body portion of the valve stem; and a flow path providing at least transient fluid communication between the internal chamber and the annular gap through the inlet; wherein a ratio of the length of the annular gap to the width of the annular gap is less than about 40:1.

In another aspect, the present invention provides a method of improving flow of an aerosol formulation in a metering valve. The method includes: a) providing a metering valve comprising i) a body wall defining an internal chamber and comprising a metering gasket and a diaphragm, the diaphragm having walls defining an aperture, ii) a valve stem comprising a body portion and a stem portion, the body portion comprising a bottom edge and being positioned in the internal chamber of the metering valve, the stem portion comprising a discharge outlet and passing through the aperture in slidable, sealing engagement with the diaphragm, iii) an annular gap comprising an inlet and having an original length defined by a distance from the inlet to the bottom edge of the body portion of the valve stem, and iv) a flow path providing at least transient fluid communication between the internal chamber and the annular gap; and b) reconfiguring the inlet, the bottom edge of the body portion of the valve stem, or both so that a new length of the annular gap is defined by a distance from the inlet to the bottom edge of the body portion of the valve stem after the reconfiguring; wherein the new length of the annular gap is less than the original length of the annular gap.

In another aspect, the present invention provides method of improving flow of aerosol formulation in a metering valve. The method includes: a) providing a metering valve comprising i) a body wall defining an internal chamber and comprising a metering gasket and a diaphragm, the diaphragm having walls defining an aperture, ii) a valve stem comprising a body portion and a stem portion, the body portion comprising a bottom edge and being positioned in the internal chamber of the metering valve in slidable, sealing engagement with the metering gasket, the stem portion comprising a discharge outlet and passing through the aperture in slidable, sealing engagement with the diaphragm, iii) an annular gap comprising an inlet and having a length defined by a distance from the inlet to the bottom edge of the body portion of the valve stem, and iv) a flow path providing at least transient fluid communication between the internal chamber and the annular gap through the inlet; b) reconfiguring the metering valve to change one or more variables in the formula:

$$P = \frac{6 LQ μ}{π {fh}^{3} R} + \frac{( 1 + K ) {Q}^{2} ρ}{8 {π}^{2} {f}^{2} {h}^{2} {R}^{2}} ,$$

wherein:

P=pressure drop,

L=length of the annulus [m],

Q=volumetric flow rate [m³/s],

μ=fluid viscosity [kg/m·s],

f=average annulus utilization [0-1],

h=distance between the inner and outer wall of the annulus [m],

R=inner radius of the annulus [m],

ρ=density of the formulation [kg/m³], and

K=entrance loss coefficient,

so that flow of formulation is improved.

### BRIEF DESCRIPTION OF THE DRAWINGS

FIG. 1 is a cross-sectional view of a metered dose inhaler including aerosol metering valve.

FIG. 2 is an enlarged cross-sectional view of an aerosol metering valve in the resting position.

FIG. 3 is a further enlarged cross-sectional view of the aerosol metering valve of FIG. 2, illustrating one embodiment of the present invention.

FIG. 4 is an enlarged cross-sectional view of an alternative aerosol metering valve in the resting position.

FIG. 5 is a further enlarged cross-sectional view of the aerosol metering valve of FIG. 4, illustrating one embodiment of the present invention.

FIG. 6 is an enlarged cross-sectional view of another alternative aerosol metering valve in the resting position.

FIG. 7a is a further enlarged cross-sectional view of the aerosol metering valve of FIG. 6 in the resting position, illustrating one embodiment of the present invention.

FIG. 7b is a further enlarged cross-sectional view of the aerosol metering valve of FIG. 6 in the filled stage of operation, illustrating one embodiment of the present invention.

FIG. 8 is an enlarged cross-sectional view of an aerosol metering valve in the filling stage of operation.

FIG. 9 is an enlarged cross-sectional view of an aerosol metering valve in the filled stage of operation.

FIG. 10 is an enlarged cross-sectional view of an aerosol metering valve in the discharging stage of operation.

### DETAILED DESCRIPTION OF ILLUSTRATIVE EMBODIMENTS OF THE INVENTION

The present invention relates to an aerosol metering valve having improved flow characteristics. The metering valve of the present invention includes an annular gap having a relatively short length. The present invention also relates to improving the flow characteristics of a metering valve by reconfiguring the metering valve so that the annular gap has a shorter length than was present in an original configuration of the metering valve.

The following description is set forth in terms of an aerosol metering valve used to dispense an aerosol formulation from an aerosol container. However, the metering valve and methods of the present invention have application to delivery of virtually any pressurized fluid requiring an accurate, metered dose. In particular, the metering valve described herein is useful for dispensing medicinal aerosol formulations.

When used to dispense a medicinal aerosol formulation, the metering valve of the present invention may be used to administer virtually any aerosol formulation of drug into a body cavity of a patient, such as the mouth, nose, anus, vagina, ears, or onto the eyes or any skin area of the patient. However, the present invention is not limited to medicinal applications and may be used wherever a precise amount of material from a pressurized fluid is to be delivered to a given region.

Various configurations of metering valves are known. Despite differences in metering valve configuration, there are many similarities in the general structure, function, and operation of metering valves that make the features of the present invention generally applicable to many metering valve designs. While the description of the invention that follows is provided in the context of a sampling of different metering valve designs, the principles embodied in the present invention are applicable to other metering valve designs as well. Consequently, the following description of the present invention should be considered illustrative and should not be construed to unduly limit the scope of the present invention.

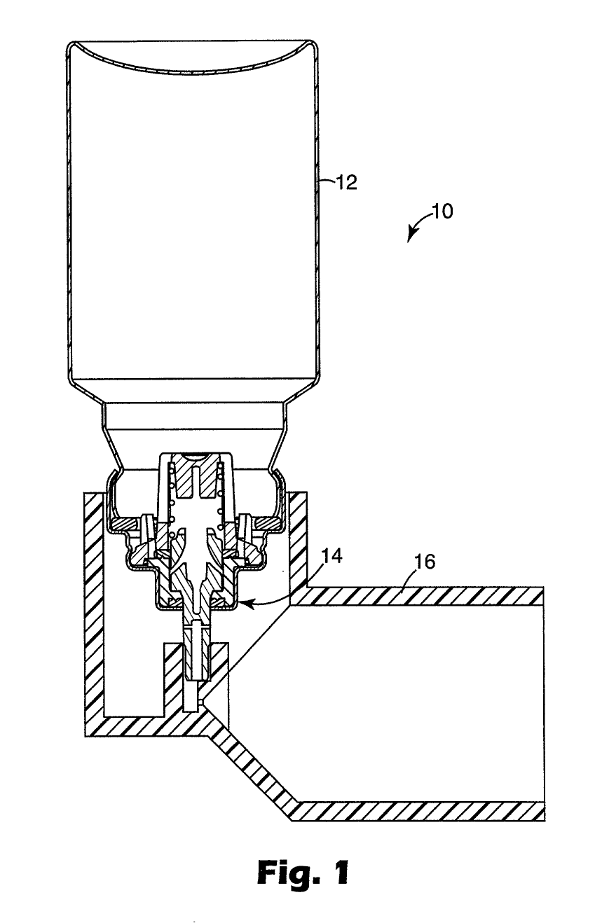

Referring to FIG. 1, an aerosol dispensing apparatus, generally designated as 10, is illustrated incorporating one metering valve design. The top end of the metering valve 14 is crimped around the end of a conventional aerosol container 12, while a conventional discharge piece 16 is mounted around the bottom of the metering valve 14. Thus, aerosol formulation is dispensed downwardly from the aerosol container 12, through the metering valve 14, then through the discharge piece 16 where it is delivered to a patient. The discharge piece 16 directs the aerosol formulation toward the body cavity or skin area to which the formulation is to be delivered. For example, discharge piece 16 may be a mouthpiece that can be inserted into the patient's mouth, thereby providing oral administration of the aerosol formulation.

The aerosol dispensing device shown in FIG. 1 is merely one example of how the metering valve can be incorporated into a dispensing apparatus. Furthermore, the configuration of the discharge piece 16 depends upon the application for the aerosol.

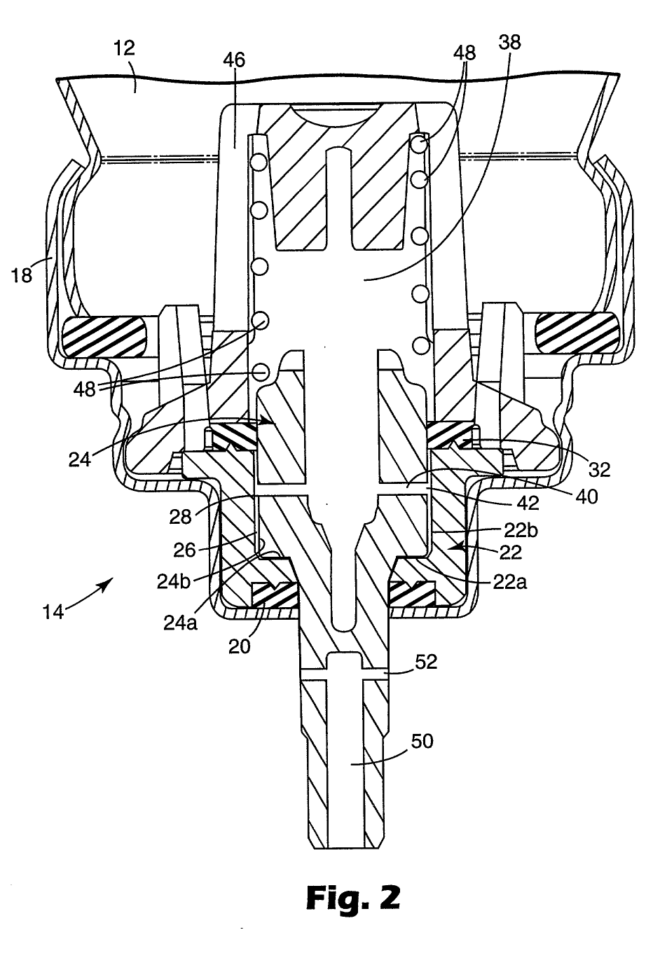

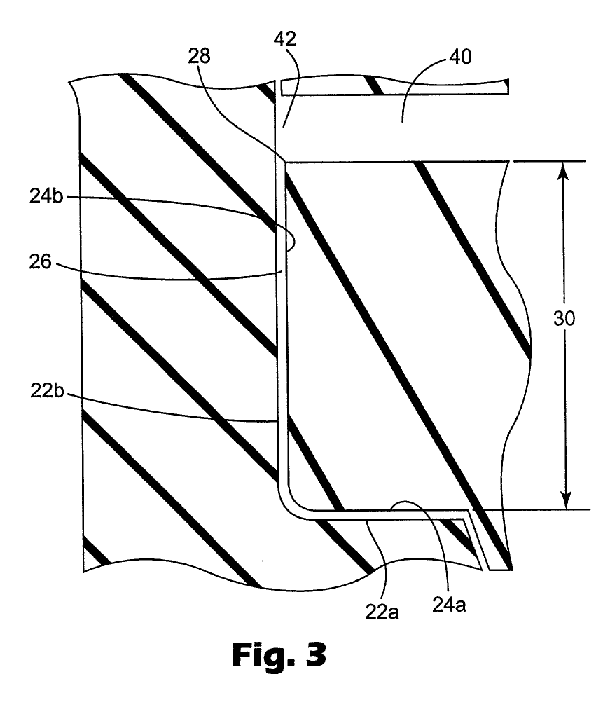

In each of FIGS. 2, 4 and 6, a metering valve design is shown in isolation for ease of illustration. While neither the aerosol container 12 nor the discharge piece 16 are completely shown in any of FIGS. 2, 4 or 6, it should be understood that the metering valve shown in each of these figures may be combined with an aerosol container 12, discharge piece 16, or both, as shown in FIG. 1. Each of FIGS. 3, 5 and 7a shows an expanded view of the metering valve design illustrated in FIGS. 2, 4 and 6, respectively. FIGS. 3, 5 and 7a illustrate the features of the present invention as applied to the metering valve designs shown in FIGS. 2, 4 and 6. It should be noted that the dimensions of the annular gaps illustrated in the figures are not intended to be drawn to scale. Specifically, for ease of illustration, the annular gaps are drawn to be larger in relation to the rest of the metering valve, in both length and width, than they may be in certain embodiments of the present invention.

Referring to FIGS. 2, 4 and 6, a different metering valve design is shown in a resting position in each figure. Each metering valve 14 generally includes a housing 18 that serves to house the various components of the metering valve 14. The top portion of the housing 18 attaches to the aerosol container 12 (as shown in FIG. 1). A valve body 22 is seated within the valve housing 18 and in turn provides a housing for a valve stem 24. The valve body may include a floor 22a and a wall 22b. The housing 18, the valve body 22 and a diaphragm 20 may be aligned so that, together, they form an aperture.

The metering valve 14 includes an interior chamber 38, a portion of which is occupied by a valve stem 24. One or more ports 46 provide fluid communication between the interior chamber 38 and the aerosol container 12. A spring 48 may serve to bias the valve stem 24 toward the resting position. However, any suitable means for biasing the valve stem 24 into the resting position may be used. Alternatively, the valve stem 24 may be unbiased.

The valve stem 24 generally includes a body portion including a bottom edge 24a and a side wall 24b. A stem portion of the valve stem 24 extends through the aperture and is in slidable, sealing contact with the diaphragm 20. The stem portion of the valve stem 24 may include a discharge outlet 50 through which a metered dose of formulation may be discharged. The discharge outlet 50 may include one or more side holes 52.

The body portion of the valve stem 24 may be generally configured to have substantially the same shape as, but to be slightly smaller than, the surrounding wall of the valve body 22b. Thus, an annular gap 26 is formed between the valve body wall 22b and the side wall of the valve stem 24b. In certain metering valve designs in which the body portion of the valve stem 24 and the valve body wall 22b are both circular in cross-section, the annular gap 26 will form a ring in cross-section. However, the body portion of the valve stem 24 and valve body wall 22b, and therefore the annular gap 26, may be any suitable shape.

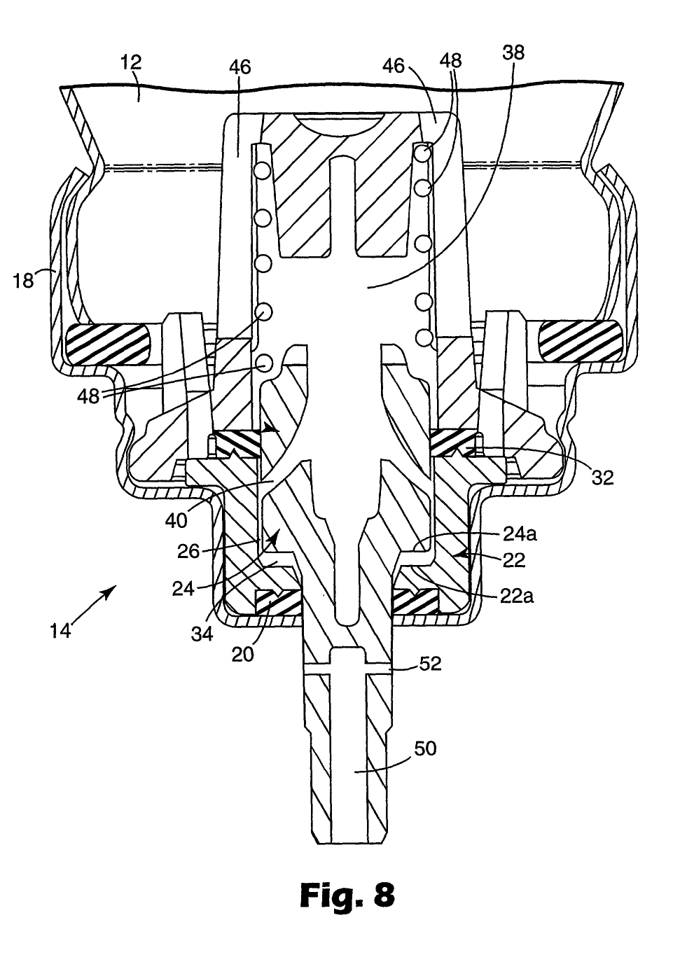

In the resting position shown in FIGS. 2, 4 and 6, the body portion of the valve stem 24 fits concentrically inside the valve body 22 and provides sufficient clearance for the annular gap 26. When the valve stem 24 is actuated, the valve stem 24 is displaced into the interior chamber 38 of the metering valve 14 and a space is created between the bottom edge of the body portion of the valve stem 24a and the floor of the valve body 22a. The space thus created forms the major part of the metering chamber 34, shown in FIG. 8 and discussed in more detail below. Because of the configuration of the body portion of the valve stem 24 and the valve body 22, only a small percentage of the metering chamber volume, that represented by the volume of the annular gap 26, is present when the metering valve 14 is in the resting position.

In each of the metering valve designs, the metering valve 14 also includes at least two annular gaskets: the diaphragm 20 and the metering gasket 32. The diaphragm 20 isolates the formulation in the aerosol container 12 from the exterior of the valve by forming three fluid tight seals: 1) an annular seal between the diaphragm 20 and the valve stem 24 where the valve stem extends out of the valve housing, 2) a compressive planar or face seal between the diaphragm 20 and the housing 18, and 3) a compressive planar or face seal between the diaphragm 20 and the valve body 22. The metering gasket 32 transiently isolates the formulation in the metering chamber 34 from the aerosol container 12 by forming two fluid tight seals: 1) an annular seal between the metering gasket 32 and the body portion of the valve stem 24, and 2) a compressive planar or face seal between the metering gasket 32 and the valve body 22. In this way, the metering gasket 32 provides a means for terminating the flow of formulation from the aerosol container 12 to the metering chamber 34 during actuation of the valve stem 24.

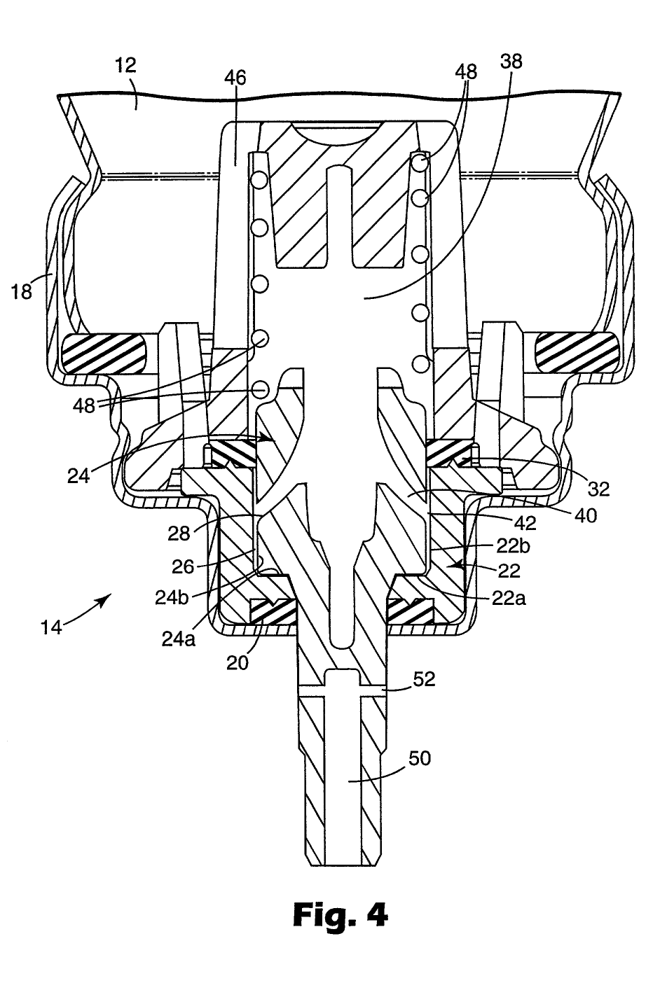

A flow path provides at least transient fluid communication between the interior chamber 38 and the annular gap 26 through an inlet 28. In some metering valve designs, shown in FIGS. 2 and 4, the flow path may include a passage 40 through the interior of the body portion of the valve stem 24. In such metering valves, the passage 40 through the interior of the body portion of the valve stem 24 provides fluid communication between the interior chamber 38 and the annular gap 26 through an opening 42. As the valve stem 24 is actuated, it is displaced into the interior chamber 38. Eventually, the extent of this displacement may be sufficient to cause the opening 42 to begin to be occluded by the metering gasket 32. Further actuation of the valve stem 24 causes the portion of the valve stem side wall 24b between the opening 42 and the stem portion of the valve stem 24 to come into sealing engagement with the metering gasket 32. At this point, the metering gasket 32 obstructs the flow path that provides fluid communication between the interior chamber 38 and the annular gap 26, thereby terminating the flow of formulation into the metering chamber 34 and isolating the metering chamber 34 from the aerosol container 12. Because the metering gasket 32 is in sealing engagement with the valve stem 24, the metering gasket 32 maintains the isolation of the metering chamber 34 from the aerosol container 12 as the valve stem 24 is actuated further, thereby preventing additional flow of formulation into the metering chamber 34.

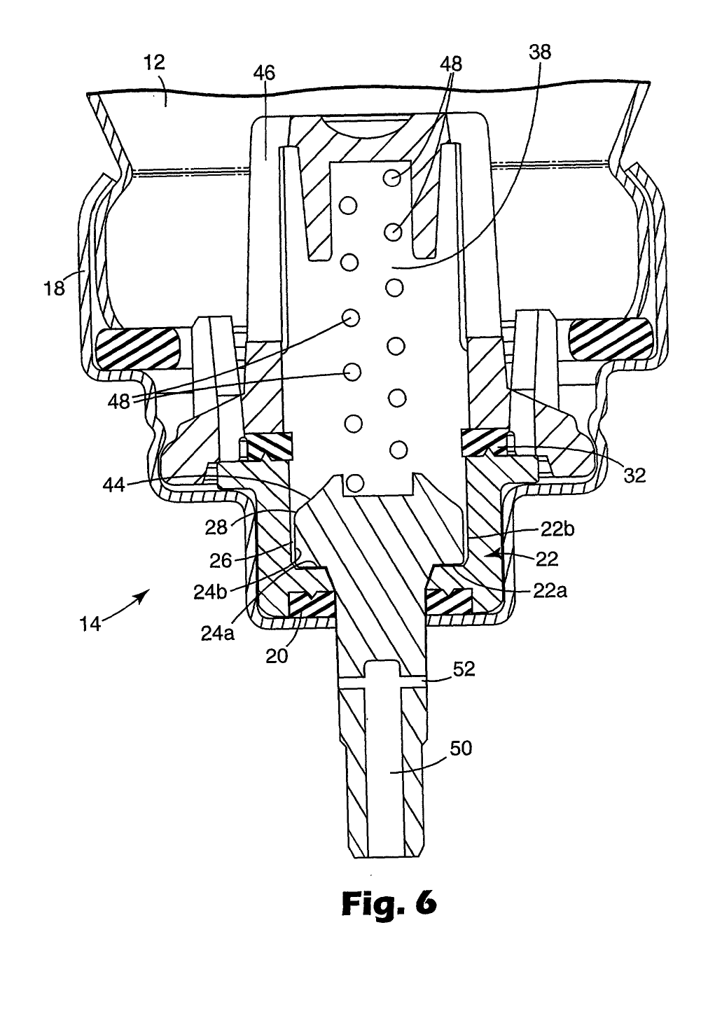

In another design, shown in FIG. 6, the flow path may exist between the metering gasket 32 and the body portion of the valve stem 24. As the valve stem 24 is actuated, it is displaced into the interior chamber 38. Eventually, the extent of this displacement will be sufficient to cause a sealing surface 44 on the valve stem 24 to contact the metering gasket 32, thereby forming a seal between the metering gasket 32 and the valve stem 24. This seal obstructs the flow path that provides fluid communication between the interior chamber 38 and the annular gap 26, thereby terminating the flow of formulation from the aerosol container 12 to the metering chamber 34. As the valve stem 24 continues to be displaced, it remains in continuous sealing contact with the metering gasket 32, thereby preventing additional flow of formulation from the aerosol container 12 to the metering chamber 34.

The annular gap 26 is shown in greater detail in FIGS. 3, 5, 7a and 7b. The annular gap 26 is defined by the space bounded by the side wall of the valve body 24b, the wall of the valve stem 22b, an inlet 28 and a line extending parallel to the horizontal axis of the valve stem from the bottom edge of the valve stem 24a. The distance between the inlet 28 and bottom edge of the valve stem 24a defines the length of the annular gap 30. In the resting position, the bottom edge of the valve stem 24a is substantially in contact with the floor of the valve body 22a. Generally, the inlet 28 is defined as the point along the flow path where the formulation first enters the tight region between the side wall of the valve stem 24b and the wall of the valve body 22b. Because different metering valve designs employ a variety of structures and valve stem configurations, the particular structures used to define the position of the inlet may vary between different metering valve designs. The inlet 28 is defined for a sample of exemplary metering valve designs in the following description. However, the inlet 28 may be defined for any metering valve design by reference to the tight region between the side wall of the valve stem 24b and the wall of the valve body 22b.

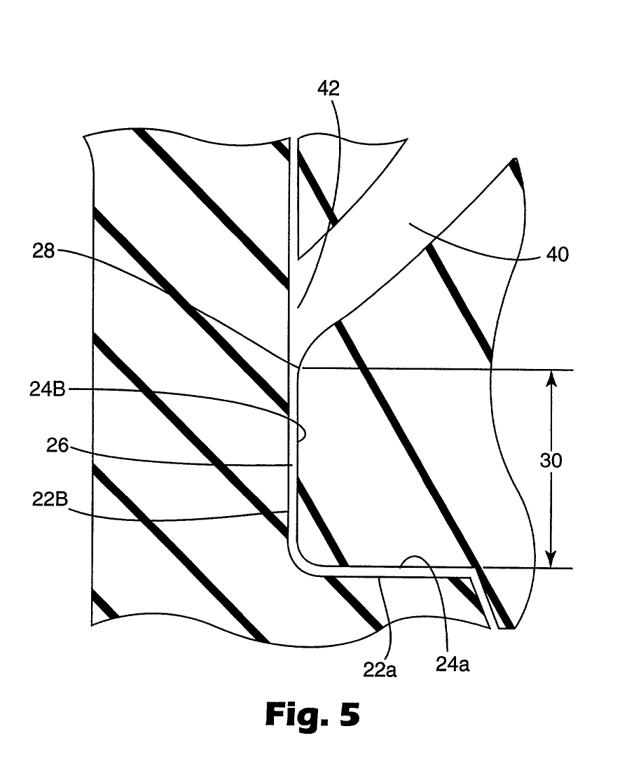

FIGS. 3 and 5 show the configuration of the annular gap 26 in a metering valve designed so that the flow path proceeds through the interior of the valve stem 24. Formulation flows through the passage 40 and into the annular gap 26 through an inlet 28. The inlet 28 is substantially parallel to the horizontal axis of the valve stem from a point at the bottom edge of the passage opening 42. If the bottom edge of the passage opening 42 forms a corner, the inlet 28 is located at the edge of the corner, as shown in FIG. 3. If the bottom edge of the passage opening 42 is rounded, the inlet 28 is located at the point at which the tangent of the curve defined by the rounding is substantially collinear with the side wall of the valve body 24b, as shown in FIG. 5. If the bottom edge of the passage opening 42 is beveled, the inlet 28 is located at the passage opening 42 corner, one side of which includes the side wall of the valve body 24b. The length of the annular gap 30 is illustrated for each of the embodiments of the present invention shown in FIGS. 3 and 5.

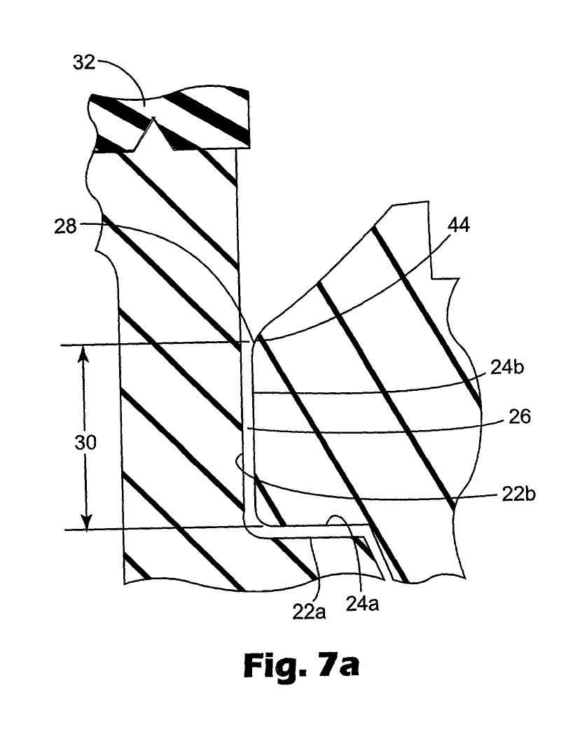

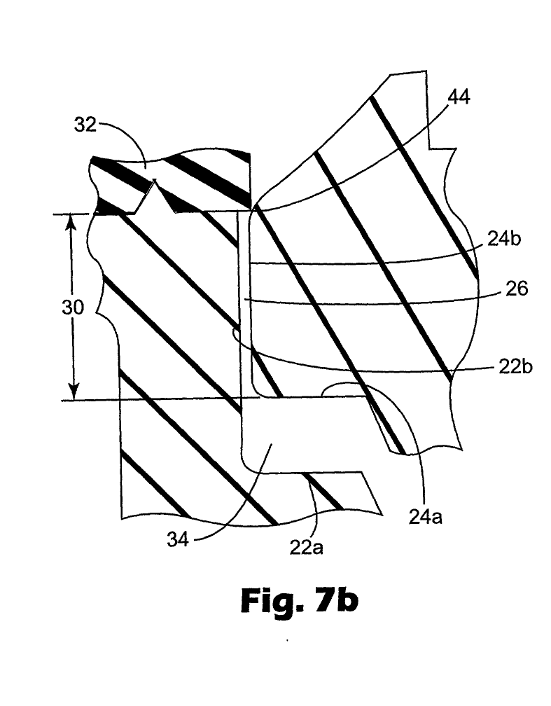

FIGS. 7a and 7b show the configuration of the annular gap 26 in a metering valve designed so that the flow path proceeds between the metering gasket 32 and the body portion of the valve stem 24. In such a metering valve, the inlet 28 is located at the point of the sealing surface 44 that first makes contact with the metering gasket 32, as shown in FIG. 7b. The length of the annular gap 30 is illustrated in each of FIGS. 7a and 7b.

As described in more detail below, the dimensions of the annular gap 26 may be designed to provide suitable performance of the metering valve 14 for delivery of a particular formulation. For example, the dimensions of the annular gap 26 may impact the flow of formulation from the aerosol container 12 into the metering chamber 34. Additionally, the dimensions of the annular gap 26 determine the volume of the annular gap and, therefore, the volume of formulation that may be present in the annular gap 26 prior to actuation of the valve stem 24.

One measure of the quality of flow of formulation in a metering valve is the pressure drop experienced by the formulation as it flows from the aerosol container 12 to the metering chamber 34. As used herein, pressure drop means an energy loss per unit volume. The energy loss is expressed in terms of an equivalent pressure difference between two points in the flow field. For example, pressure drop may exist in a flow path where a fluid is forced to turn sharply at relatively high speed. If the pressure drop is of sufficient magnitude, the formulation may be subject to cavitation, leading to inaccurate or ineffective dosing. Cavitation of the formulation is thus undesirable. Consequently, it may be desirable to be able to design a metering valve that has improved flow characteristics so that the risk of cavitation of the formulation is reduced. One way to accomplish this objective is to design a metering valve so that the pressure drop experienced by the formulation is reduced.

The relationship between pressure drop and the length of the annular gap may be determined to a first order of approximation according to Formula I, provided below. Formula I assumes laminar flow through a uniform cylindrical annular gap with a valve stem radius significantly larger than the width of the annular gap. Moreover, Formula I applies to the flow of formulation in various designs of metering valves so long as the metering valve design includes an annular gap.

$$Formula I \text{:}$$

$$P = \frac{6 LQ μ}{π {fh}^{3} R} + \frac{( 1 + K ) {Q}^{2} ρ}{8 {π}^{2} {f}^{2} {h}^{2} {R}^{2}} ,$$

wherein:

P=pressure drop,

L=length of the annular gap [m],

Q=volumetric flow rate [m³/s],

μ=fluid viscosity [kg/m·s],

f=average annular gap utilization [0-1],

h=width of the annular gap [m],

R=inner radius of the annular gap (or radius of the valve stem) [m],

ρ=density of the formulation [kg/m³], and

K=entrance loss coefficient.

Thus, with all other variables held constant, pressure drop varies according to the length of the annular gap. In fact, if the viscous contribution to pressure drop,

$${P}_{visc} = \frac{6 LQ μ}{π {fh}^{3} R} ,$$

is much greater than the kinetic energy contribution to pressure drop,

$${P}_{KE} = \frac{( 1 + K ) {Q}^{2} ρ}{8 {π}^{2} {f}^{2} {h}^{2} {R}^{2}} ,$$

such as may occur when the formulation is very viscous, then total pressure drop, P, varies almost in direct proportion to the length of the annular gap.

Therefore, designing a metering valve with a minimal annular gap length minimizes the pressure drop and, therefore, reduces the likelihood and extent of cavitation of the formulation.

As stated above, Formula I assumes a uniform cylindrical annular gap in which the width of the annular gap (h) is constant. However, the principles of the present invention apply equally to metering valves in which the width of the annular gap varies. For example, a non-uniform annular gap width may be apparent along the length of the gap in a vertical cross-section. Alternatively, a non-uniform annular gap width may be apparent radially in a horizontal cross-section. For the purposes of approximating the pressure drop (P) according to Formula I, the width of the annular gap (h) for a metering valve having a non-uniform annular gap width is accounted for by integrating differential forms of the formula over the non-uniformity. For example, the pressure drop in a metering valve having a non-uniform annular gap width that is apparent in vertical cross-section may be approximated by integrating differential forms of Formula I along the length of the annular gap. Alternatively, the pressure drop in a metering valve having a non-uniform annular gap width that is apparent in horizontal cross-section may be approximated by integrating differential forms of Formula I azimuthally. Regardless of the particular nature of the non-uniform annular gap, pressure drop is generally reduced if the length of the annular gap (L) is shortened according to Formula I. Consequently, the flow of formulation is improved if the length of the annular gap is shortened regardless of any variation in the width of the annular gap.

For purposes not directly related to approximating pressure drop by using Formula I, such as computing a ratio of the length of the annular gap to the width of the annular gap, the width of a non-uniform annular gap may be approximated by selecting a representative annular gap width. For such purposes, one may select a maximum width, a minimum width or an average width of the non-uniform annular gap as a representative annular gap width.

In accordance with the principles described above, one embodiment of the present invention includes an annular gap having a length of about 3.2 mm. Various alternative embodiments include an annular gap having a length of about 2.0 mm, about 1.0 mm, about 0.4 mm or about 0.1 mm. Certain embodiments of the present invention include an annular gap having a width of about 0.08 mm. Various alternative embodiments include an annular gap having a width of about 0.1 mm, about 0.05 mm, about 0.025 mm, or about 0.01 mm. Greater widths, such as about 0.2 mm, about 0.5 mm or 1.0 mm, are also possible if desired for a particular application.

Operation of the Metering Valve

The various metering valve designs described above operate in a similar manner to one another. Between doses, each metering valve design described above exists in a resting position. Actuation of the metering valve involves the valve stem passing sequentially through at least three stages of operation in order to dispense a dose of formulation: a filling stage, a filled stage and a discharging stage. After dispensing a dose of formulation, the metering valve returns to the resting position. The operation of the metering valves will be described below in greater detail with some description provided for the differences in operation resulting from differences in configuration of the various metering valve designs. However, the principles of the present invention are equally applicable to all of the metering valve designs described, as well as to designs not described, herein.

In the filling stage, shown in FIG. 8, the valve stem 24 is displaced inwardly into the interior chamber 38. As the valve stem 24 is displaced inwardly, the metering chamber 34 is formed between the floor of the valve body 22a and the bottom edge of the valve stem 24a. The volume of the metering chamber 34 increases as the valve stem is displaced.

The aerosol formulation enters the filling volume of the metering chamber 34 in the following manner. Formulation from the aerosol container 12 passes through the one or more metering valve ports 46 and into the interior chamber 38 of the metering valve. From the interior chamber 38, the formulation follows the flow path to the annular gap 26. In the metering valve design shown in FIGS. 2-5, the flow path follows the passage 40 through the interior of the valve stem. In the metering valve design shown in FIGS. 6, 7a and 7b, the flow path proceeds between the metering gasket 32 and the valve stem 24. In either design, as the valve stem 24 is moved from the resting position into the filling stage, aerosol formulation passes from the aerosol container 12 to the metering chamber 34 immediately upon actuation of the valve stem 24. Formulation continues to fill the metering chamber 34 until the metering valve 14 reaches the filled stage.

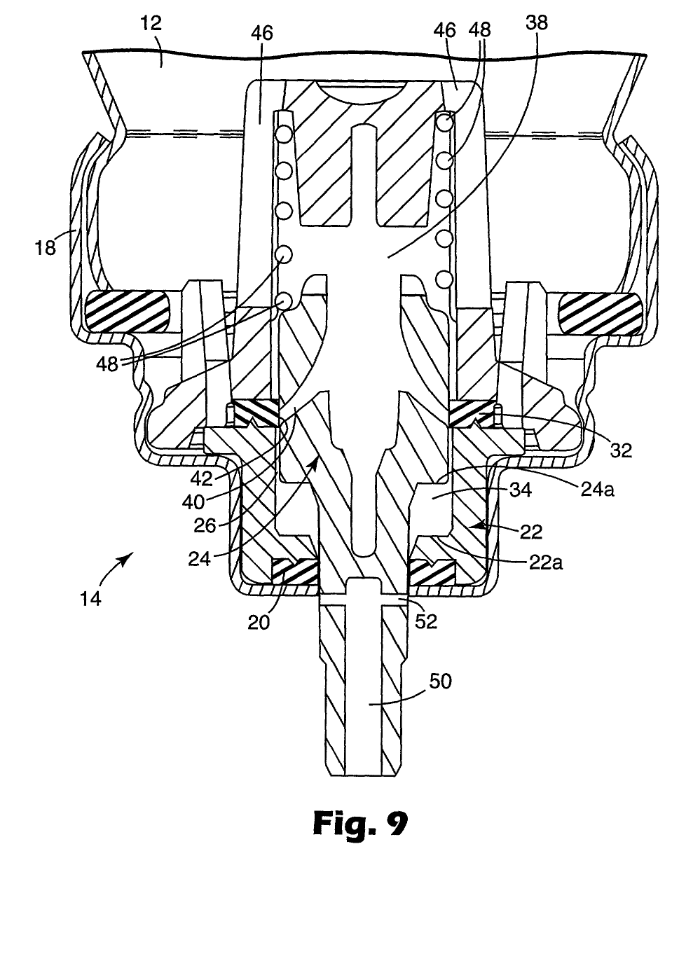

The filled stage, shown in FIG. 9, is characterized by the metering gasket 32 obstructing the flow path, thereby terminating the flow of formulation from the aerosol container 12 to the metering chamber 34. In the metering valve design shown in FIGS. 2-5, the metering gasket 32 terminates the flow of formulation by providing sealing engagement with the portion of the valve stem side wall 24b located between the passage opening 42 and the stem portion of the valve stem. In the metering valve design shown in FIGS. 6, 7a and 7b, the metering gasket 32 terminates flow of formulation by forming a seal with the sealing surface 44 of the valve stem 24, as shown in FIG. 7b. In each design, the metering gasket 32 forms and maintains a fluid seal around the valve stem 24 even as the valve stem 24 continues to be displaced inwardly with respect to the metering gasket 32. Maintenance of this fluid seal prevents any additional flow of formulation into the metering chamber 34 so that filling of the metering chamber 34 is concluded. At this stage, the metered dose of formulation is isolated and ready for discharge from the metering chamber 34 and delivery to the patient. The dimensions of the valve body 22, valve stem 24 and other valve components determine the volume of the metering chamber 34 in the filled stage of operation.

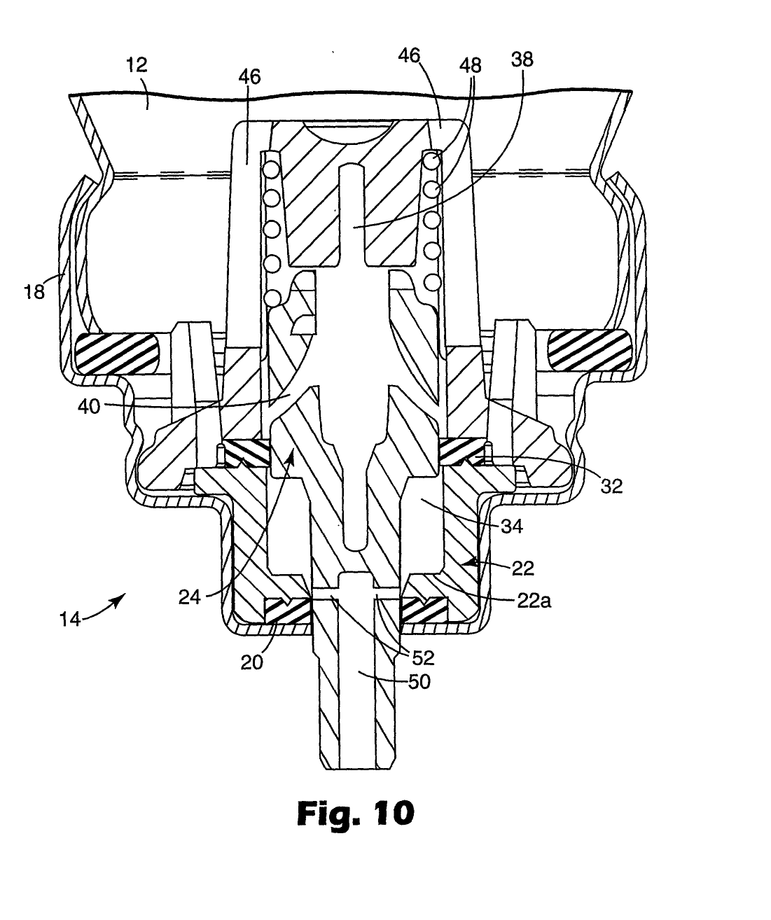

As the valve stem 24 is further displaced inwardly during actuation, the metering valve progresses to the discharge stage of operation, shown in FIG. 10. As the valve stem 24 is further actuated, the one or more side holes 52 of the discharge outlet 50 pass through the diaphragm 20 and come into fluid communication with the metering chamber 34. That fluid communication allows the aerosol formulation within the metering chamber 34 to be released into the one or more side holes 52 and the formulation thus passes through the discharge outlet 50, thereby delivering the metered dose of aerosol formulation to the patient or other desired area.

During the discharge of the aerosol formulation from the metering chamber 34, the seal between the valve stem 24 and the metering gasket 32 continues to prevent the passage of additional bulk formulation from the aerosol container 12 to the metering chamber 34.

After the dose of aerosol formulation is discharged, the valve stem 24 is returned to the original resting position. The valve stem 24 may be returned to the resting position by the biasing action of the spring 48, or, alternatively, by some other means such as manipulation by the patient.

The successive stages of valve stem actuation are all accomplished during the brief duration of actuation of the valve stem 24. Accordingly, formation, filling and emptying of the metering chamber 34 occurs rapidly. Only a small percentage of a dose of formulation resides in the metering chamber 34 between discharges, and the metering chamber 34 is full of formulation only for a brief moment immediately prior to discharge of the formulation from the metering chamber 34. Subsequent release of the valve stem by the patient allows the valve to return from the position of the valve stem 24 during the discharge stage to the resting position. During the return of the valve stem 24 to the resting position, formulation may enter the metering chamber 34 as soon as the metering gasket 32 no longer occludes the flow path into the metering chamber 34. While cavitation of formulation may occur at this time, subsequent travel of the valve stem 24 as it completes its return to the resting position causes the formulation to be returned to the interior chamber 38 via the annular gap 26. An annular gap having a short length helps to ensure purging of the residual vapor and ease of return of the valve stem 24 against the force due to viscous drag.

The complete disclosures of the patents, patent documents and publications cited herein are incorporated by reference in their entirety as if each were individually incorporated. In case of conflict, the present specification, including definitions, shall control.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

What is claimed is:

1. An aerosol metering valve comprising:
a body wall defining an internal chamber and comprising a metering gasket and a diaphragm, the diaphragm having walls defining an aperture;
a valve stem comprising a body portion and a stem portion, the body portion comprising a bottom edge and being positioned in the internal chamber of the metering valve, the stem portion comprising a discharge outlet and passing through the aperture in slidable, sealing engagement with the diaphragm;
an annular gap comprising an inlet and having a length of about 3.2 mm or less, wherein the length of the annular gap is defined by the distance from the bottom edge of the body portion of the valve stem to the inlet; and
a flow path providing at least transient fluid communication between the internal chamber and the annular gap through the inlet.

2. The aerosol metering valve of claim 1 wherein the flow path comprises a passageway through the body portion of the valve stem.

3. The aerosol metering valve of claim 1 wherein the flow path comprises a clearance between the body portion of the valve stem and the metering gasket.

4. The aerosol valve of claim 1 wherein the length of the annular gap is about 2.0 mm or less.

5. The aerosol valve of claim 1 wherein the length of the annular gap is about 1.0 mm or less.

6. The aerosol valve of claim 1 wherein the length of the annular gap is about 0.4 mm or less.

7. The aerosol valve of claim 1 wherein the length of the annular gap is about 0.1 mm or less.

8. An aerosol metering valve comprising:
a body wall defining an internal chamber and comprising a metering gasket and a diaphragm, the diaphragm having walls defining an aperture;
a valve stem comprising a body portion and a stem portion, the body portion comprising a bottom edge and being positioned in the internal chamber of the metering valve, the stem portion comprising a discharge outlet and passing through the aperture in slidable, sealing engagement with the diaphragm;
an annular gap comprising an inlet and having a width defined by the distance from the body wall to the valve stem, and also having a length defined by the distance from the inlet to the bottom edge of the body portion of the valve stem, and wherein a ratio of the length of the annular gap to the width of the annular gap is less than about 40:1; and a flow path providing at least transient fluid communication between the internal chamber and the annular gap through the inlet.

9. The aerosol metering valve of claim 8 wherein the distance from the body wall to the valve stem is substantially uniform, and wherein the width of the annular gap equals the distance from the body wall to the valve stem.

10. The aerosol metering valve of claim 8 wherein the distance from the body wall to the valve stem is non-uniform and comprises a maximum distance, and wherein the width of the annular gap equals the maximum distance.

11. The aerosol metering valve of claim 8 wherein the flow path comprises a passageway through the body portion of the valve stem.

12. The aerosol metering valve of claim 8 wherein the flow path comprises a clearance between the body portion of the valve stem and the metering gasket.

13. The aerosol metering valve of claim 8 wherein the ratio of the length of the annular gap to the width of the annular gap is less than about 25:1.

14. The aerosol metering valve of claim 8 wherein the ratio of the length of the annular gap to the width of the annular gap is less than about 20:1.

15. The aerosol metering valve of claim 8 wherein the ratio of the length of the annular gap to the width of the annular gap is less than about 12.5:1.

16. The aerosol metering valve of claim 8 wherein the ratio of the length of the annular gap to the width of the annular gap is less than about 5:1.

17. The aerosol metering valve of claim 8 wherein the ratio of the length of the annular gap to the width of the annular gap is less than about 2:1.

18. The aerosol metering valve of claim 8 wherein the ratio of the length of the annular gap to the width of the annular gap is less than about 1:1.

19. An aerosol metering valve comprising:
a body wall defining an internal chamber and comprising a metering gasket and a diaphragm, the diaphragm having walls defining an aperture;
a valve stem comprising a body portion and a stem portion, the body portion comprising a bottom edge and being positioned in the internal chamber of the metering valve, the stem portion comprising a discharge outlet and passing through the aperture in slidable, sealing engagement with the diaphragm;
an annular gap comprising an inlet and having a width defined by the distance from the body wall to the valve stem, and also having a length of about 3.2 mm or less, defined by the distance from the inlet to the bottom edge of the body portion of the valve stem, wherein a ratio of the length of the annular gap to the width of the annular gap is less than about 320:1; and
a flow path providing at least transient fluid communication between the internal chamber and the annular gap through the inlet.

20. The aerosol metering valve of claim 19 wherein the distance from the body wall to the valve stem is substantially uniform, and wherein the width of the annular gap equals the distance from the body wall to the valve stem.

21. The aerosol metering valve of claim 19 wherein the distance from the body wall to the valve stem is non-uniform and comprises a maximum distance, and wherein the width of the annular gap equals the maximum distance.

22. The aerosol metering valve of claim 19 wherein the flow path comprises a passageway through the body portion of the valve stem.

23. The aerosol metering valve of claim 19 wherein the flow path comprises a clearance between the body portion of the valve stem and the metering gasket.

24. The aerosol metering valve of claim 19 wherein the ratio of the length of the annular gap to the width of the annular gap is less than about 200:1.

25. The aerosol metering valve of claim 19 wherein the ratio of the length of the annular gap to the width of the annular gap is less than about 128:1.

26. The aerosol metering valve of claim 19 wherein the ratio of the length of the annular gap to the width of the annular gap is less than about 100:1.

27. The aerosol metering valve of claim 19 wherein the ratio of the length of the annular gap to the width of the annular gap is less than about 80:1.

28. The aerosol metering valve of claim 19 wherein the ratio of the length of the annular gap to the width of the annular gap is less than about 64:1.

29. A method of improving flow of an aerosol formulation in a metering valve comprising:
a) providing a metering valve comprising
i) a body wall defining an internal chamber and comprising a metering gasket and a diaphragm, the diaphragm having walls defining an aperture,
ii) a valve stem comprising a body portion and a stem portion, the body portion comprising a bottom edge and being positioned in the internal chamber of the metering valve, the stem portion comprising a discharge outlet and passing through the aperture in slidable, sealing engagement with the diaphragm,
iii) an annular gap comprising an inlet and having an original length defined by the distance from the inlet to the bottom edge of the body portion of the valve stem, and
iv) a flow path providing at least transient fluid communication between the internal chamber and the annular gap; and
b) reconfiguring the inlet, the bottom edge of the body portion of the valve stem, or both so that a new length of the annular gap is defined by the distance from the inlet to the bottom edge of the body portion of the valve stem after the reconfiguring;
wherein the new length of the annular gap is less than the original length of the annular gap.

30. The method of claim 29 wherein the flow path comprises a passageway through the body portion of the valve stem.

31. The method claim 29 wherein the flow path comprises a clearance between the body portion of the valve stem and the metering gasket.

32. A method of improving flow of aerosol formulation in a metering valve comprising:
a) providing a metering valve comprising
i) a body wall defining an internal chamber and comprising a metering gasket and a diaphragm, the diaphragm having walls defining an aperture,
ii) a valve stem comprising a body portion and a stem portion, the body portion comprising a bottom edge and being positioned in the internal chamber of the metering valve in slidable, sealing engagement with the metering gasket, the stem portion comprising a discharge outlet and passing through the aperture in slidable, sealing engagement with the diaphragm,
iii) an annular gap comprising an inlet and having a length defined by the distance from the inlet to the bottom edge of the body portion of the valve stem, and
iv) a flow path providing at least transient fluid communication between the internal chamber and the annular gap through the inlet;
b) reconfiguring the metering valve to change one or more variables in the formula:
$$P = \frac{6 LQ μ}{π {fh}^{3} R} + \frac{( 1 + K ) {Q}^{2} ρ}{8 {π}^{2} {f}^{2} {h}^{2} {R}^{2}} ,$$
wherein:
P=pressure drop,
L=length of the annulus [m],
Q=volumetric flow rate [m³/s],
μ=fluid viscosity [kg/m·s],
f=average annulus utilization [0-1],
h=distance between the inner and outer wall of the annulus [m],
R=inner radius of the annulus [m],
ρ=density of the formulation [kg/m³], and
K=entrance loss coefficient,
so that flow of formulation is improved.

33. The method of claim 32 wherein the flow path comprises a passageway through the body portion of the valve stem.

34. The method of claim 32 wherein the flow path comprises a clearance between the body portion of the valve stem and the metering gasket.
